(19) United States
(12) Patent Application Publication
(10) Pub. No.: US 2023/0365028 A1
(43) Pub. Date: Nov. 16, 2023

(54) VEHICLE SEAT CONTROL DEVICE AND VEHICLE SEAT

(71) Applicant: NHK SPRING CO., LTD., Yokohama-shi (JP)

(72) Inventors: Kenichi Katsube, Yokohama-shi (JP); Atsuo Matsumoto, Yokohama-shi (JP); Tsuyoshi Matsuzawa, Yokohama-shi (JP)

(21) Appl. No.: 18/312,473

(22) Filed: May 4, 2023

(30) Foreign Application Priority Data
May 13, 2022 (JP) 2022-079796

(51) Int. Cl. B60N 2/02; B60N 2/20

(52) U.S. Cl. CPC B60N 2/0248; B60N 2/20

(57) ABSTRACT

A vehicle seat control device, includes: a memory; a processor connected to the memory; a reclining unit that tilts, along a seat front-rear direction relative to a seat cushion on which an occupant sits, a seatback that supports an upper body of the seated occupant sitting on the seat cushion; and a sliding unit that is provided at a seat width direction outer side of the seat cushion and that slides, along the seat front-rear direction, an armrest that supports an arm of the seated occupant, wherein the processor is configured to perform control to slide the armrest via the sliding unit while maintaining a preset positional relationship between the seatback and the armrest in conjunction with an operation whereby the seatback is tilted along the seat front-rear direction via the reclining unit.

### CROSS-REFERENCE TO RELATED APPLICATION

This application is based on and claims priority under 35 USC 119 from Japanese Patent Application No. 2022-079796 filed on May 13, 2022, the disclosure of which is incorporated by reference herein.

### BACKGROUND

### Technical Field

The present disclosure relates to a vehicle seat control device and a vehicle seat.

### Related Art

Japanese Patent Application Laid-open (JP-A) No. 2017-109616 discloses art relating to a seat control device capable of switching between an autonomous driving mode and a manual driving mode. In this prior art, a seatback drive unit that adjusts the angle of a seatback of a vehicle seat and an armrest drive unit that moves the position of an armrest are connected to an autonomous driving control ECU. When switching from the autonomous driving mode to the manual driving mode, the adjustment of the angle of the seatback and the movement of the armrest are controlled by the autonomous driving control ECU, whereby a driver is assisted to a manually drivable state.

Specifically, in the prior art, the armrest is movable between a first position near a steering wheel and a second position away from the steering wheel so that the armrest does not hinder driving. The autonomous driving control ECU, when switching from the autonomous driving mode to the manual driving mode, is set to move the armrest to the first position to prompt the driver to return to manual driving, and thereafter move the armrest to the second position in which the armrest does not hinder driving.

As described above, in the prior art, the seatback and the armrest are individually movable.

However, in a case where the seatback and the armrest are individually movable, a gap between the armrest and seatback changes, and the gap may become too narrow or too wide.

### SUMMARY

In consideration of the above circumstances, the present disclosure provides a vehicle seat control device and a vehicle seat that can maintain a predetermined positional relationship between an armrest and a seatback even when the seatback is tilted.

A vehicle seat control device pertaining to a first aspect includes: a reclining unit that tilts, along a seat front-rear direction relative to a seat cushion on which an occupant sits, a seatback that supports an upper body of the seated occupant sitting on the seat cushion; and a sliding unit that is provided at a seat width direction outer side of the seat cushion and that slides, along the seat front-rear direction, an armrest that supports an arm of the seated occupant. Wherein the vehicle seat control device performs control to slide the armrest via the sliding unit while maintaining a preset positional relationship between the seatback and the armrest in conjunction with an operation whereby the seatback is tilted along the seat front-rear direction via the reclining unit.

The vehicle seat control device pertaining to the first aspect includes the reclining unit and the sliding unit. The seatback can be tilted along the seat front-rear direction relative to the seat cushion by the reclining unit, and the armrest can be slid along the seat front-rear direction by the sliding unit.

Here, the vehicle seat control device performs control to slide the armrest via the sliding unit while maintaining the preset positional relationship between the seatback and the armrest in conjunction with the operation whereby the seatback is tilted along the seat front-rear direction via, the reclining unit.

For this reason, in the present disclosure, when the seatback tilts, the armrest slides while maintaining the preset positional relationship between the seatback and the armrest. In other words, in the present disclosure, the positional relationship between the seatback and the armrest is set to not change even when the seatback is tilted.

It will be noted that “in conjunction with” in the present disclosure does not necessarily mean that the seatback and the armrest need to be synchronized but rather means moving the armrest in accompaniment with the tilting of the seatback so that the seatback and the armrest maintain a predetermined positional relationship.

Furthermore, regarding the “preset positional relationship between the seatback and the armrest,” the preset positional relationship includes a setting in a predetermined range, and in this case, as long as the preset positional relationship is in the predetermined range, there are also cases where the armrest does not slide even when the seatback is reclined.

A vehicle seat control device pertaining to a second aspect is the vehicle seat control device pertaining to the first aspect, wherein the preset positional relationship between the seatback and the armrest is configured such that a rear end portion of the armrest in the seat front-rear direction overlaps with a front end portion of the seatback in the seat front-rear direction in a seat side view.

In the vehicle seat control device pertaining to the second aspect, the preset positional relationship between the seatback and the armrest is configured such that the rear end portion of the armrest overlaps with the front end portion of the seatback in a seat side view, so no gap is formed between the front end portion of the seatback and the rear end portion of the armrest as a result of the seatback being tined.

A vehicle seat control device pertaining to a third aspect is the vehicle seat control device pertaining to the first aspect, wherein the preset positional relationship between the seatback and the armrest is configured such that a preset predetermined gap is provided between a rear end portion of the armrest in the seat front-rear direction and a front end portion of the seatback in the seat front-rear direction in a seat side view.

In the vehicle seat control device pertaining to the third aspect, the preset positional relationship between the seatback and the armrest is configured such that the preset predetermined gap is provided between the rear end portion of the armrest and the front end portion of the seatback in a seat side view, so the gap does not go away between the front end portion of the seatback and the rear end portion of the armrest as a result of the seatback being tilted.

A vehicle seat control device pertaining to a fourth aspect is the vehicle seat control device pertaining to the first aspect, further including a first position detection device that is provided in the seatback and detects a position of the seatback in the seat front-rear direction, a first drive device that is provided in the reclining unit and tilts the seatback along the seat front-rear direction, a second position detection device that is provided in the armrest and detects a position of the armrest in the seat front-rear direction, and a second drive device that is provided in the sliding unit and slides the armrest along the seat front-rear direction, wherein the vehicle seat control device performs control to drive the first drive device and the second drive device after detecting, via the first position detection device, the seat front-rear direction position of the seatback and detecting, via the second position detection device, the seat front-rear direction position of the armrest.

The vehicle seat control device pertaining to the fourth aspect further includes the first position detection device, the first drive device, the second position detection device, and the second drive device. The first position detection device is provided in the seatback and detects the seat front-rear direction position of the seatback. The first drive device is provided in the reclining unit and tilts the seatback along the seat front-rear direction. The second position detection device is provided in the armrest and detects the seat front-rear direction position of the armrest. The second drive device is provided in the sliding unit and slides the armrest along the seat front-rear direction.

Additionally, the vehicle seat control device drives the first drive device and the second drive device after detecting, via the first position detection device, the seat front-rear direction position of the seatback and detecting, via the second position detection device, the seat front-rear direction position of the armrest. In other words, the control device slides the armrest via the sliding unit so as to maintain the preset positional relationship between the seatback and the armrest in conjunction with the operation whereby the seatback is tilted via the reclining unit.

In this way, because the vehicle seat control device detects the seat front-rear direction position of the seatback and the seat front-rear direction position of the armrest before tilting the seatback, the vehicle seat control device can reliably slide the armrest in conjunction with the tilting of the seatback so as to maintain the preset positional relationship between the seatback and the armrest.

A vehicle seat control device pertaining to a fifth aspect is the vehicle seat control device pertaining to the fourth aspect, wherein the vehicle seat control device performs control so as to not drive the second drive device in a case in which a detection result obtained by at least one of the first position detection device or the second position detection device is not input.

In the vehicle seat control device pertaining to the fifth aspect, the control device performs control to not drive the second drive device that slides the armrest along the seat front-rear direction in a case in which a detection result obtained by at least one of the first position detection device that detects the seat front-rear direction position of the seatback or the second position detection device that detects the seat front-rear direction position of the armrest is not input. This ensures that there is not a situation where the armrest slides along the seat front-rear direction despite the positions of the seatback and the armrest not being detected.

A vehicle seat pertaining to a sixth aspect includes the vehicle seat control device of any one of the first aspect to the fifth aspect, wherein the armrest is attached to the seat cushion.

In the vehicle seat control device pertaining to the sixth aspect, the armrest is attached to the seat cushion, so compared with a case where the armrest is provided on a center console or a door trim, for example, the positional relationship between the armrest and the seatback can be set in the vehicle seat by itself, so it becomes easier to control.

As described above, the vehicle seat control device and the vehicle seat pertaining to the present disclosure can maintain a predetermined positional relationship between an armrest and a seatback even when the seatback is tilted.

### BRIEF DESCRIPTION OF THE DRAWINGS

An exemplary embodiment of the present disclosure will be described in detail based on the following figures, wherein:

FIG. 1 is a perspective view of a vehicle seat pertaining to the embodiment as viewed obliquely from the front left side;

FIG. 2 is a side view showing the vehicle seat pertaining to the embodiment in a state in which a seatback is upright;

FIG. 3 is a side view showing the vehicle seat pertaining to the embodiment in a state in which the seatback is reclined;

FIG. 4 is a block diagram showing configurations of a vehicle seat control device pertaining to the embodiment;

FIG. 5 is an enlarged sectional view, corresponding to FIG. 2, showing main portions of an armrest;

FIG. 6 is an enlarged sectional view, corresponding to FIG. 3, showing main portions of the armrest;

FIG. 7 is a flowchart showing a flow of control by the vehicle seat control device pertaining to the embodiment;

FIG. 8 is a side view showing an example modification of the vehicle seat pertaining to the embodiment in a state in which the seatback is upright;

FIG. 9 is a side view showing an example modification of the vehicle seat pertaining to the embodiment in a state in which the seatback is reclined;

FIG. 10 is a side view showing a vehicle seat pertaining to a comparative example in a state in which a seatback is upright; and

FIG. 11 is a side view showing the vehicle seat pertaining to the comparative example in a state in which the seatback is reclined.

### DETAILED DESCRIPTION

A vehicle seat 10 pertaining to an embodiment of the present disclosure will be described below with reference to the drawings. It will be noted that arrow FR, arrow UP, and arrow OUT shown in the drawings indicate a forward direction, an upward direction, and an outward direction, respectively, of the vehicle seat 10. The front-rear direction, the left and right direction (vehicle width direction), and the up and down direction of the vehicle seat 10 coincide with the front-rear direction, the left and right direction (width direction), and the up and down direction of a vehicle (automobile) in which the vehicle seat 10 is installed. Hereinafter, when description is given simply using the directions of front, rear, left, right, upper, and lower, these directions are to be understood as directions relative to the vehicle seat 10 unless otherwise specified.

(Configurations of Vehicle Seat)

First, the configurations of the vehicle seat 10 pertaining to the embodiment will be described.

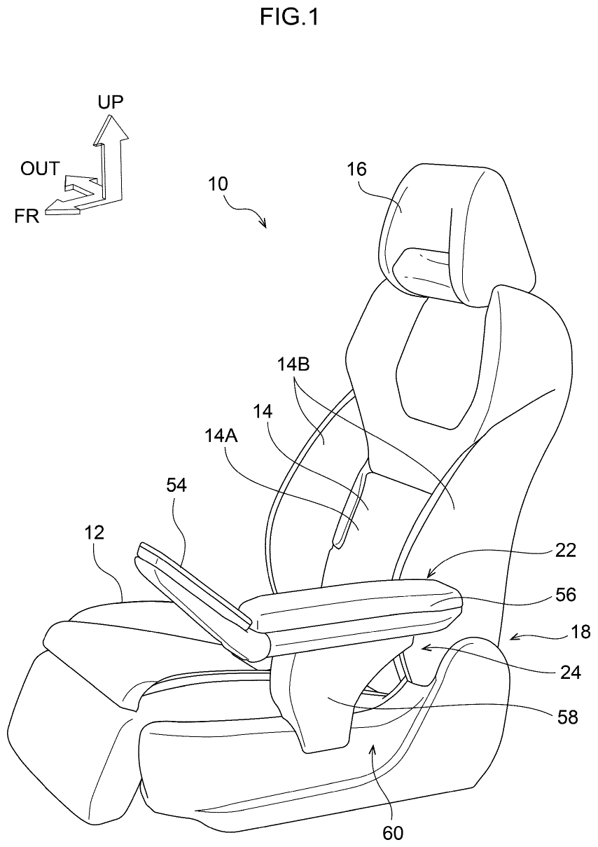

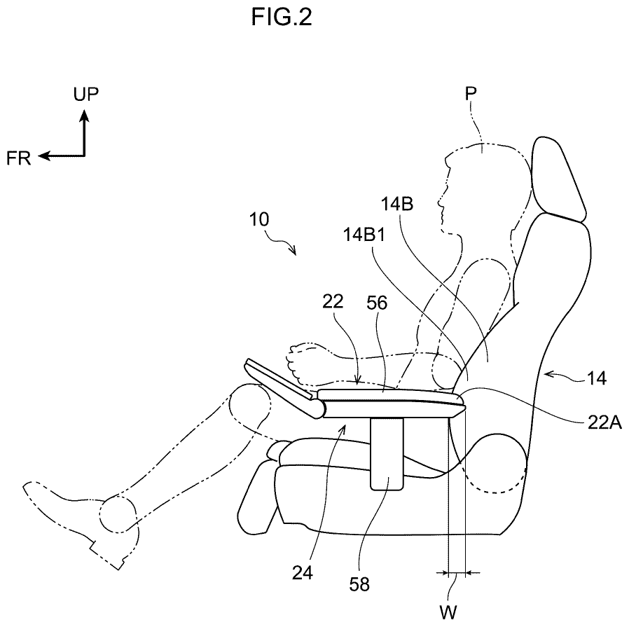

FIG. 1 shows a perspective view of the vehicle seat 10 pertaining to the embodiment. The vehicle seat 10 is configured to include a seat cushion 12 that supports the thighs and lumbar region of a seated occupant P(see FIG. 2), a seatback 14 that supports an upper body of the seated occupant P, and a headrest 16 that supports the head of the seated occupant P.

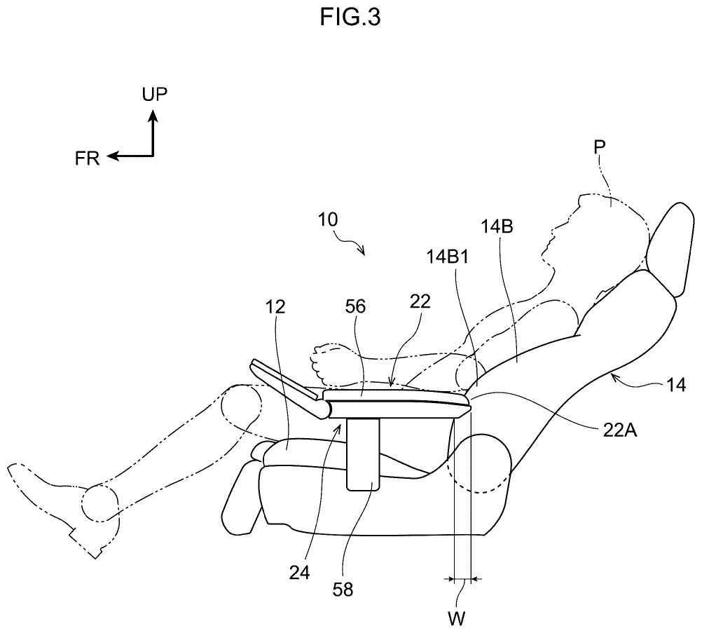

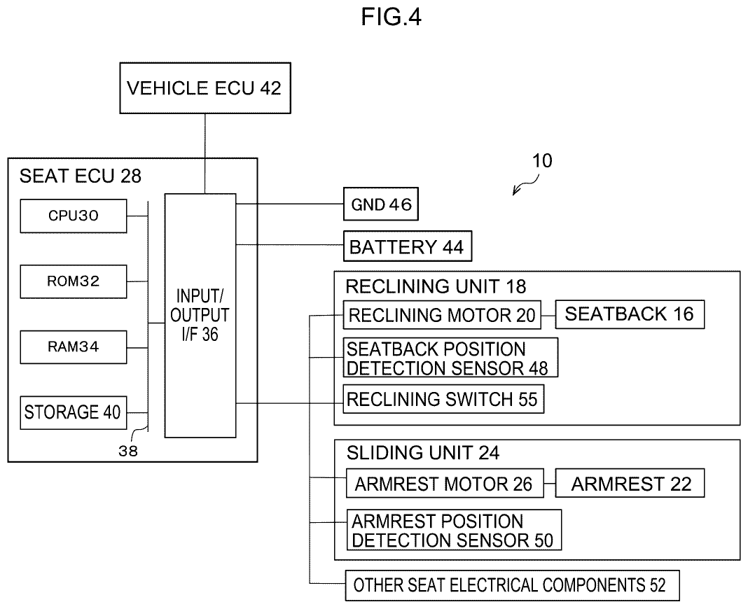

In the lower end portion of the seatback 14 is provided a reclining unit 18. The reclining unit 18 is, as shown in FIG. 4, configured to include a reclining motor (a first drive device) 20. When the reclining motor 20 is driven, the seatback 14 tilts as shown in FIG. 2 and FIG. 3 along the seat front-rear direction relative to the seat cushion 12 about a shaft portion (not shown in the drawings) provided in the lower end portion of the seatback 14.

An armrest 22 that supports an arm of the seated occupant P is attached to the vehicle width direction inner side of the seat cushion 12.

In this embodiment, the armrest 22 is configured such that a rear end portion 22A of the armrest 22 overlaps (an overlap W) with a front end portion 141B1 of the seatback 14 in a seat side view (described later). Here, as shown in FIG. 1, the seatback 14 is configured to include a main portion 14A, which supports the upper body of the seated occupant P(see FIG. 2) from the back, and side portions 14B, which are provided on both seat width direction sides of the main portion 14A and enable the upper body of the seated occupant P to be supported from the sides. For this reason, the side portions 14B project forward beyond the main portion 14A in a seat side view. Consequently, the front end portion 1481 of the seatback 14 here becomes the side portions 14B.

Furthermore, in the armrest 22 in this embodiment is provided a sliding unit 24. The sliding unit 24 is, as shown in FIG. 4, configured to include an armrest motor (a second drive device) 26, and when the armrest motor 26 is driven, the armrest 22 slides as shown in FIG. 2 and FIG. 3 along the seat front-rear direction (described later). It will be noted that, although the drawings do not show this, the armrest 22 may be provided on the vehicle width direction inner side and outer side of the seat cushion 12.

Furthermore, as shown in FIG. 4, the vehicle seat 10 is also provided with a seat electronic control unit (ECU) 28 serving as a vehicle seat control device. The seat ECU 28 includes a central processing unit (CPU) 30, a read-only memory (ROM) 32, a random-access memory (RAM) 34, an input/output interface (I/F) 36, and a storage 40 that are connected to each other via a bus 38.

The CPU 30 is a central processing unit, executes various types of programs, and controls each part of the seat ECU 28. The ROM 32 stores various types of programs and various types of data. The RAM 34 temporarily stores programs or data as a workspace. The storage 40 is configured by a hard disk drive (HDD) or a solid-state drive (SSD) and stores various types of programs, including an operating system, and various types of data.

That is, the CPU 30 reads programs from the ROM 32 or the storage 40 and executes the programs using the RAM 34 as a workspace. Furthermore, the CPU 30 controls each of the above configurations and executes various types of arithmetic processing in accordance with the programs recorded in the ROM 32 or the storage 40.

Here, a vehicle ECU 42, a battery 44, and a GND 46 installed in the vehicle are electrically connected to the input/output interface 36 of the seat ECU 28. The reclining motor 20 and the armrest motor 26 are also electrically connected to the input/output interface 36 of the seat ECU 28.

Moreover, a seatback position detection sensor (hereinafter simply called “the seatback sensor”) 48 serving as a first position detection device and an armrest position detection sensor (hereinafter simply called “the armrest sensor”) 50 serving as a second position detection device are electrically connected to the input/output interface 36 of the seat ECU 28.

The seatback sensor 48 is a sensor that detects a position of the seatback 14 in the front-rear direction (see FIG. 2 and FIG. 3), and the armrest sensor 50 is a sensor that detects a position of the armrest 22 in the front-rear direction (see FIG. 2 and FIG. 3).

It will be noted that Hall-effect ICs, for example, are used as the seatback sensor 48 and the armrest sensor 50. In this case, the Hall-effect ICs are configured such that pulse signals according to the rotation of output shafts of the reclining motor 20 and the armrest motor 26 are output to the seat ECU 28, and the front-rear direction positions of the seatback 14 and the armrest 22 are detected as a result of the seat ECU 28 counting and adding up the pulse signals.

Furthermore, in addition to the above but not shown in the drawings, other seat electrical components 52, such as a seat sliding motor that moves the vehicle seat 10 forward and rearward, a lifter motor that moves the vehicle seat 10 up and down, and a seat heater that heats the seat cushion 12 and the seatback 14 (none of which are shown in the drawings), are electrically connected to the seat ECU 28.

These devices electrically connected to the input/output interface 36 of the seat ECU 28 in this way are respectively controlled by the seat ECU 28.

In this embodiment, as shown in FIG. 1, an operation panel 54 is provided on the front side of the armrest 22. The operation panel 54 is provided so as to slope in the seat upward direction heading in the seat forward direction, and is configured such that the occupant P can easily operate it.

The operation panel 54 is provided with a reclining switch 55 (see FIG. 4) for tilting the seatback 14 and, although the drawings do not show them, a sliding switch for moving the vehicle seat 10 forward and backward and a lifter switch for moving the vehicle seat 10 up and down. These switches are also electrically connected to the seat ECU 28, and when the occupant P touches these switches, the seat ECU 28 activates the corresponding devices.

In this connection, in this embodiment, the armrest 22 is configured to include a main body portion 56 and a leg portion 58. The main body portion 56 configures the upper portion of the armrest 22, the leg portion 58 configures the lower portion of the armrest 22, and the main body portion 56 is slidable along the front-rear direction relative to the leg portion 58.

The leg portion 58 is, in a seat side view in the shape of an inverted trapezoidal box formed so that its with dimension in the front-rear direction becomes narrower heading downward. It will be noted that FIG. 2 and FIG. 3 show the shape of the leg portion 58 simplified. Furthermore, as shown in FIG. 1, the lower end portion of the leg portion 58 is secured to a side finish 60 that covers, from outside in the seat width direction, a seat cushion frame (not shown in the drawing) configuring a skeletal member of the seat cushion 12.

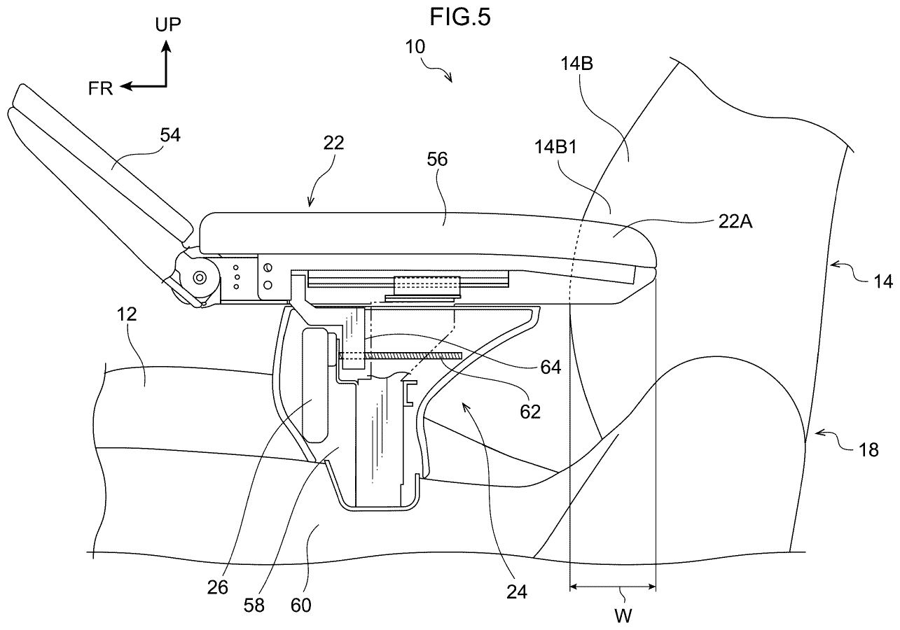

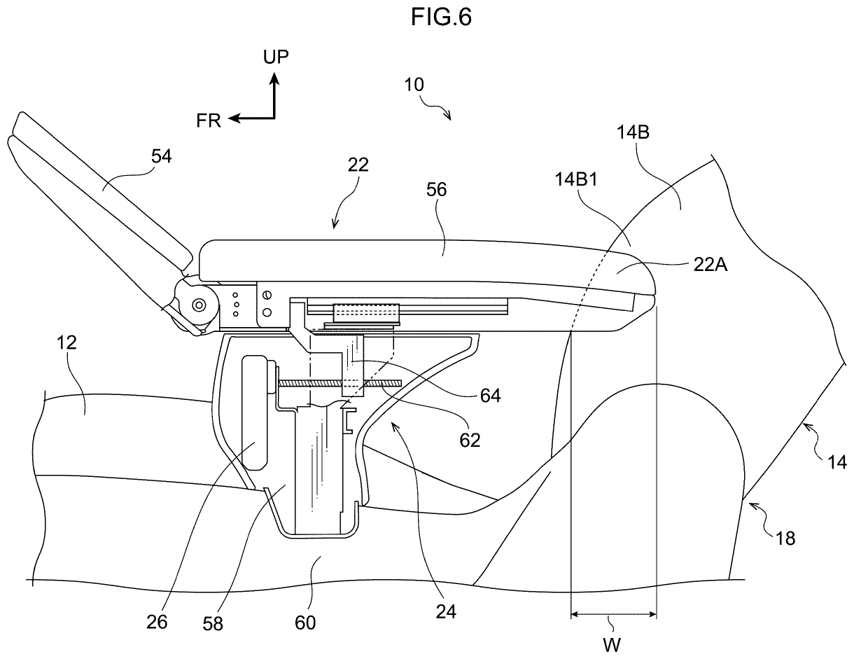

Here, as shown in FIG. 5 and FIG. 6, the armrest motor 26 is provided inside the leg portion 58. Furthermore, a ball screw 62 is disposed along the front-rear direction inside the leg portion 58, and the ball screw 62 is connected to the armrest motor 26. For this reason, when the armrest motor 26 is driven, the ball screw 62 rotates.

A nut 64 is screwed onto the ball screw 62, and the nut 64 is moved along the axial direction of the ball screw 62 (the front-rear direction) by the rotation of the ball screw 62. The main body portion 56 is integrated with the nut 64, and the main body portion 56 is moved along the front-rear direction relative to the leg portion 58 by the movement of the nut 64.

It will be noted that although in this embodiment the ball screw 62 and the nut 64 are used to slide the main body portion 56 of the armrest 22 along the front-rear direction, the method of sliding the main body portion 56 along the front-rear direction is not limited to this because the rotational force of the armrest motor 26 need only be able to be converted to linear motion to slide the main body portion 56 along the front-rear direction. For example, although the drawings do not show this, a rack and pinion may also be used.

(Action and Effects of Vehicle Seat)

Next, the action and effects of the vehicle seat 10 pertaining to this embodiment will be described.

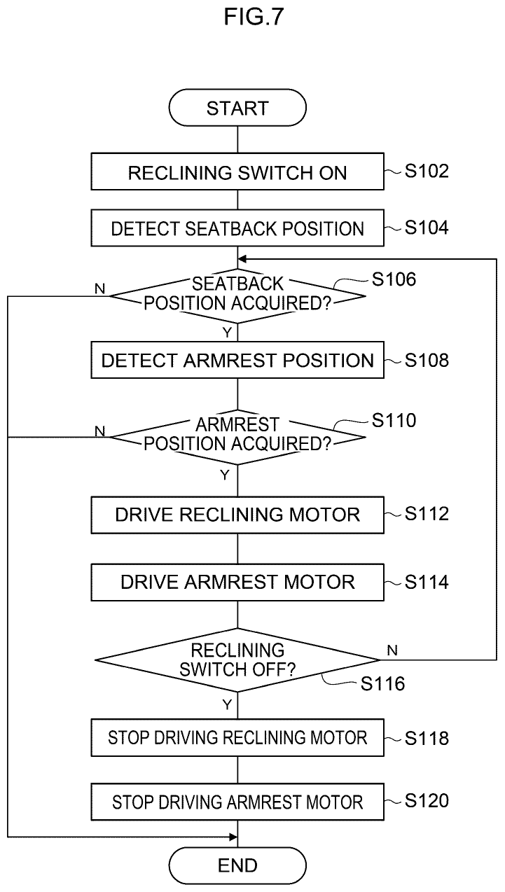

FIG. 7 is a flowchart showing processes in the seat ECU 28 with which the vehicle seat 10 pertaining to this embodiment is equipped. The action of the seat ECU 28 will be described in accordance with this flowchart with reference to FIG. 4.

As shown in FIG. 7, when the reclining switch 55 is pressed (switched ON) in step S102, the CPU 30 of the seat ECU 28 detects in step S104 the front-rear direction position of the seatback 14.

Next, the CPU 30 judges in step S106 whether or not the front-rear direction position of the seatback 14 has been acquired. The CPU 30 moves to the process of step S108 when the front-rear direction position of the seatback 14 is acquired in step S106 (step S106: Y).

Then, when the CPU 30 detects in step S108 the front-rear direction position of the armrest 22, the CPU 30 judges in step S11.0 whether or not the front-rear direction position of the armrest 22 has been acquired.

When the front-rear direction position of the armrest 22 is acquired in step S110 (step S110: Y), the CPU 30 drives the reclining motor 20 in step S112 and drives the armrest motor 26 in step S114.

Here, although the processes of step S112 and step S114 are described separately, they are performed at substantially the same time because in this embodiment the armrest 22 is set to slide in conjunction with the reclining operation of the seatback 14.

Next, the CPU 30 judges in step S116 whether or not the reclining switch 55 has been released (switched OFF). When the reclining switch 55 is switched OFF in step S116 (step S116: Y), the CPU 30 stops driving the reclining motor 20 in step S118 and stops driving the armrest motor 26 in step S120.

Here, although the processes of step S118 and step S120 are described separately, they are performed at substantially the same time because in this embodiment the armrest 22 is set to slide in conjunction with the reclining operation of the seatback 14.

The CPU 30 ends the flow in a case where the front-rear direction position of the seatback 14 is not acquired in step S106 (step S106: N).

The CPU 30 also ends the flow in a case where the front-rear direction position of the armrest 22 is not acquired in step S110 (step S110: N).

Moreover, the CPU 30 moves to step S106 in a case where the reclining switch 55 is not switched OFF in step S116 (step S116: N). In other words, in this embodiment, the CPU 30 repeats the processes of step S106 to step S114 until the reclining switch 55 is switched OFF.

The action of this embodiment will now be specifically described.

In this embodiment, as shown in FIG. 4, the vehicle seat 10 is equipped with the reclining unit 18, the sliding unit 24, and the seat ECU 28. The seatback 14 can be tilted along the seat front-rear direction by the reclining unit 18, and the armrest 22 can be slid along the seat front-rear direction by the sliding unit 24.

The seat ECU 28 slides the armrest 22 via the sliding unit 24 so as to maintain a preset positional relationship between the seatback 14 and the armrest 22 in conjunction with the operation whereby the seatback 14 is tilted along the seat front-rear direction via the reclining unit 18.

Furthermore, in this embodiment, the seat ECU 28 further includes the seatback sensor 48, the reclining motor 20, the armrest sensor 50, and the armrest motor 26. The seatback sensor 48 is provided in the seatback 14 and detects the seat front-rear direction position of the seatback 14, and the reclining motor 20 is provided in the reclining unit 18 and tilts the seatback 14 along the seat front-rear direction. The armrest sensor 50 is provided in the armrest 22 and detects the seat front-rear direction position of the armrest 20, and the armrest motor 26 is provided in the sliding unit 24 and slides the armrest 22 along the seat front-rear direction.

Because of the above configuration, in this embodiment, when the reclining switch 55 is switched ON, the seat ECU 28 drives the reclining motor 20 and the armrest motor 26 after detecting, via the seatback sensor 48, the seat front-rear direction position of the seatback 14 and detecting, via the armrest sensor 50, the seat front-rear direction position of the armrest 22.

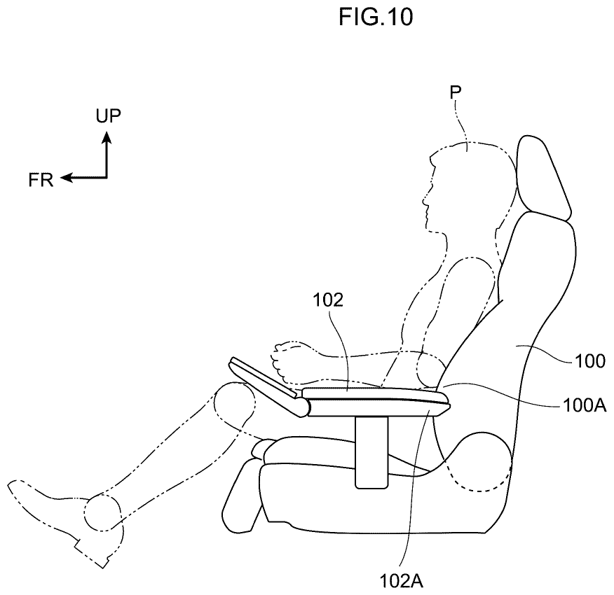

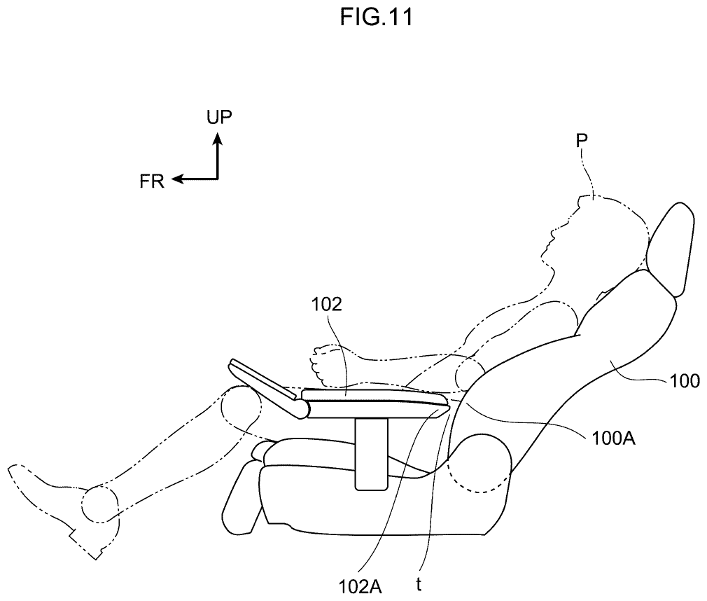

For example, as a comparative example, even when, as shown in FIG. 10, a rear end portion 102A of an armrest 102 overlaps with a front end portion 100A of a seatback 100 in a seat side view in a state in which the seatback 100 is upright, when the seatback 100 is reclined, as shown in FIG. 11, a gap t ends up being provided between the rear end portion 102A of the armrest 102 and the front end portion 100A of the seatback 100. In other words, in the comparative example, the positional relationship between the armrest 102 and the seatback 100 changes due to the reclining of the seatback 100, and the gap t may become too narrow or too wide.

In contrast, in this embodiment, as shown in FIG. 2, in a state in which the seatback 14 is upright, the positional relationship between the seatback 14 and the armrest 22 is configured such that the rear end portion 22A of the armrest 22 overlaps (the overlap W) with the front end portion 14B1 of the seatback 14 in a seat side view. Moreover, in this embodiment, the armrest 22 slides so as to maintain the preset positional relationship between the seatback 14 and the armrest 22 in conjunction with the operation whereby the seatback 14 is tilted.

For this reason, in this embodiment, the reclining motor 20 and the armrest motor 26 shown in FIG. 4 are driven so that, even when the seatback 14 is reclined as shown in FIG. 3, the rear end portion 22A of the armrest 22 and the front end portion 14B1 of the seatback 14 overlap with each other in a seat side view (the overlap W).

In other words, in this embodiment, as shown in FIG. 2 and FIG. 3, the positional relationship between the front end portion 14B1 of the seatback 14 and the rear end portion 22A of the armrest 22 is set to be maintained and not change even when the seatback 14 is tilted.

Furthermore, in this embodiment, the seat ECU 28 detects the seat front-rear direction position of the seatback 14 and the seat front-rear direction position of the armrest 22 before tilting the seatback 14, so the armrest 22 can be reliably slid in conjunction with the tilting of the seatback 14 so as to maintain the preset positional relationship between the seatback 14 and the armrest 22.

In this embodiment, the seat ECU 28 shown in FIG. 4 ends the flow in a case where, in steps S106 and S110 of FIG. 7, a detection result obtained by at least one of the seatback sensor 48 that detects the seat front-rear direction position of the seatback 14 or the armrest sensor 50 that detects the seat front-rear direction position of the armrest 22 is not input. In other words, the seat ECU 28 is set to not drive the armrest motor 26 in, for example, a case where at least one of the seatback sensor 48 or the armrest sensor 50 is faulty.

In this embodiment, as mentioned above, the seat ECU 28 shown in FIG. 4 slides the armrest 22 via the sliding unit 24 so as to maintain the preset positional relationship between the seatback 14 and the armrest 22 in conjunction with the operation whereby the seatback 14 is tilted along the seat front-rear direction via the reclining motor 18.

For this reason, it is ensured that there is not a situation where, despite the positions of the seatback 14 and the armrest 22 not being detected, the armrest 22 slides along the seat front-rear direction such that the preset positional relationship between the seatback 14 and the armrest 22 does not hold.

Furthermore, in this embodiment, the armrest 22 is attached to the seat cushion 12. For this reason, compared with a case where, although the drawings do not show this, the armrest 22 is provided on a center console or a door trim, the positional relationship between the armrest 22 and the seatback 14 can be set in the vehicle seat by itself, so it becomes easier to control. However, in the present disclosure, the positional relationship between the seatback and the armrest need only be able to be maintained even when the seatback tilts, so although the drawings do not show this, the armrest may of course also be provided on a center console or a door trim.

In this embodiment, as shown in FIG. 2 and FIG. 3, the armrest 22 is configured such that the rear end portion 22A of the armrest 22 overlaps (the overlap W) with the front end portion 14B1 of the seatback 14 in a seat side view regardless of the tilting operation of the seat-back 14. However, in the present disclosure, the armrest is not limited to this because the armrest need only be able to be slid in the front-rear direction so as to maintain a preset positional relationship between the seatback and the armrest in conjunction with the operation whereby the seatback is tilted.

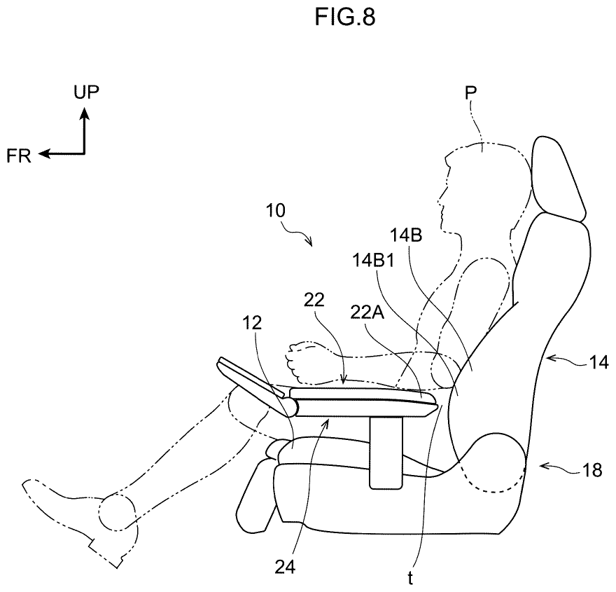

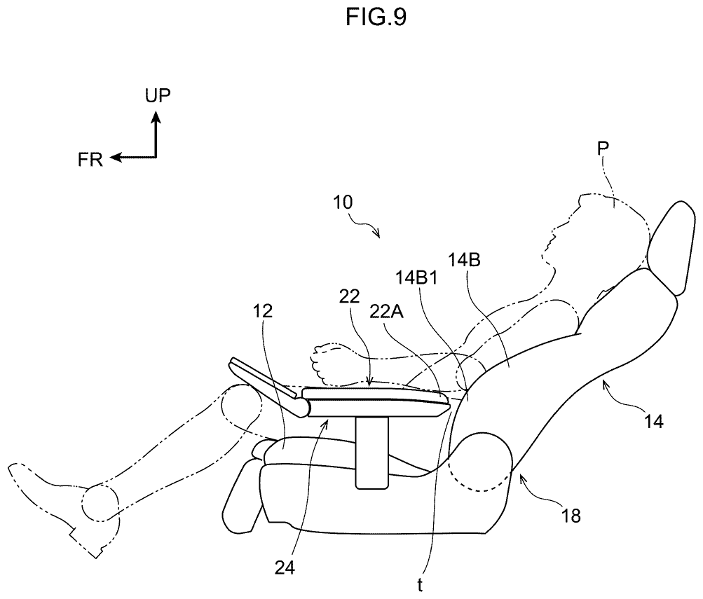

For example, as shown in FIG. 8 and FIG. 9, the positional relationship between the seatback 14 and the armrest 22 may also be set in such a way that a predetermined gap t is provided between the rear end portion 22A of the armrest 22 and the front end portion 14B1 of the seatback 14 in a seat side view regardless of the tilting operation of the seatback 14.

In this case, the reclining motor 20 and the armrest motor 26 shown in FIG. 4 are driven so that, even when the seatback 14 is reclined as shown in FIG. 3, the state in which the predetermined gap t is provided between the rear end portion 22A of the armrest 22 and the front end portion 14B1 of the seatback 14 in a seat side view is maintained. It will be noted that the gap t may have a predetermined range.

In other words, in this embodiment, as shown in FIG. 8 and FIG. 9, the positional relationship between the front end portion 14B1 of the seatback 14 and the rear end portion 22A of the armrest 22 is maintained even when the seatback 14 is tilted, and the gap t does not go away between the front end portion 14B1 of the seatback 14 and the rear end portion 22A of the armrest 22 as a result of the seatback 14 being tilted.

Furthermore, in the above embodiment, the armrest 22 is set to slide along the front-rear direction in conjunction with the operation whereby the seatback 14 is tilted. In other words, the armrest 22 is set to slide in conjunction with the operation of the seatback 14, but the armrest 22 is not necessarily limited to this.

For example, the armrest 22 may also be slidable along the front-rear direction on its own. In this case, when reclining the seatback 14, the processes shown in FIG. 7 may be performed after the position of the armrest 22 has been returned to the preset positional relationship between the seatback 14 and the armrest 22.

Furthermore, in addition to the above, the armrest 22 may be slid in conjunction with the reclining operation of the seatback 14 so as to maintain the positional relationship between the seatback 14 and the armrest 22 in a state in which the armrest 22 has been slid on its own.

In addition, the present disclosure can be changed in various ways and implemented in a range that does not depart from the spirit thereof. Furthermore, the scope of rights of the present disclosure is not limited to the above embodiment.

<Supplementary Notes>

The following configurations may be combined as appropriate to configure the vehicle seat pertaining to the disclosure.

(Configuration 1)

A vehicle seat control device including: a reclining unit that tilts, along a seat front-rear direction relative to a seat cushion on which an occupant sits, a seatback that supports the upper body of the seated occupant sitting on the seat cushion; and a sliding unit that is provided at a seat width direction outer side of the seat cushion and that slides, along the seat front-rear direction, an armrest that supports an arm of the seated occupant, wherein the vehicle seat control device performs control to slide the armrest via the sliding unit while maintaining a preset positional relationship between the seatback and the armrest in conjunction with an operation whereby the seatback is tilted along the seat front-rear direction via the reclining unit,

(Configuration 2)

The vehicle seat control device, wherein the preset positional relationship between the seatback and the armrest is configured such that a seat front-rear direction rear end portion of the armrest overlaps with a front end portion of the seatback in the seat front-rear direction in a seat side view

(Configuration 3)

The vehicle seat control device, wherein the preset positional relationship between the seatback and the armrest is configured such that a preset predetermined gap is provided between a rear end portion of the armrest in the seat front-rear direction and a front end portion of the seatback in the seat front-rear direction in a seat side view.

(Configuration 4)

The vehicle seat control device, further including a first position detection device that is provided in the seatback and detects a position of the seatback in the seat front-rear direction, a first drive device that is provided in the reclining unit and tilts the seatback along the seat front-rear direction, a second position detection device that is provided in the armrest and detects a position of the armrest in the seat front-rear direction, and a second drive device that is provided in the sliding unit and slides the armrest along the seat front-rear direction, wherein the vehicle seat control device performs control to drive the first drive device and the second drive device other detecting, via the first position detection device, the seat front-rear direction position of the seatback and detecting, via the second position detection device, the seat front-rear direction position of the armrest.

(Configuration 5)

The vehicle seal control device, wherein the vehicle seat control device performs control so as to not drive the second drive device in a case in which a detection result obtained by at least one of the first position detection device or the second position detection device is not input.

In addition, the present disclosure can be changed in various ways and implemented in a range that does not depart from the spirit thereof. Furthermore, the scope of rights of the present disclosure is not limited to the above embodiment.

What is claimed is:

1. A vehicle seat control device, comprising:
a memory;
a processor connected to the memory;
a reclining unit that tilts, along a seat front-rear direction relative to a seat cushion on which an occupant sits, a seatback that supports an upper body of the seated occupant sitting on the seat cushion; and
a sliding unit that is provided at a seal width direction outer side of the seat cushion and that slides, along the seat front-rear direction, an armrest that supports an arm of the seated occupant,
wherein the processor is configured to perform control to slide the armrest via the sliding unit while maintaining a preset positional relationship between the seatback and the armrest in conjunction with an operation whereby the seatback is tilted along the seat front-rear direction via the reclining unit.

2. The vehicle seat control device of claim 1, wherein the preset positional relationship between the seatback and the armrest is configured such that a rear end portion of the armrest in the seat front-rear direction overlaps with a front end portion of the seatback in the seat front-rear direction in a seat side view.

3. The vehicle seat control device of claim 1, wherein the preset positional relationship between the seatback and the armrest is configured such that a preset predetermined gap is provided between a rear end portion of the armrest in the seat front-rear direction and a front end portion of the seatback in the seat front-rear direction in a seat side view.

4. The vehicle seat control device of claim 1, further comprising:
a first position detection device that is provided in the seatback and detects a position of the seatback in the seat front-rear direction,
a first drive device that is provided in the reclining unit and tilts the seatback along the seat front-rear direction,
a second position detection device that is provided in the armrest and detects a position of the armrest in the seat front-rear direction, and
a second drive device that is provided in the sliding unit and slides the armrest along the seat front-rear direction,
wherein the processor is configured to perform control to drive the first drive device and the second drive device after detecting, via the first position detection device, the seat front-rear direction position of the seatback and detecting, via the second position detection device, the seat front-rear direction position of the armrest.

5. The vehicle seat control device of claim 4, wherein the processor is configured to perform control so as to not drive the second drive device in a case in which a detection result obtained by at least one of the first position detection device or the second position detection device is not input.

6. A vehicle seat comprising the vehicle seat control device of claim 1, wherein the armrest is attached to the seat cushion.
